(19) United States
(12) Patent Application Publication
(10) Pub. No.: US 2024/0193206 A1
(43) Pub. Date: Jun. 13, 2024

(54) INTERACTION METHOD AND APPARATUS, ELECTRONIC DEVICE, AND COMPUTER-READABLE STORAGE MEDIUM

(71) Applicant: Beijing Bytedance Network Technology Co., Ltd., Beijing (CN)

(72) Inventors: Can YANG, Beijing (CN); Wenjing LIU, Beijing (CN); Xu LIU, Beijing (CN)

(21) Appl. No.: 18/555,427

(22) PCT Filed: Mar. 22, 2022
(86) PCT No.: PCT/CN2022/082134

§ 371 Date: Oct. 13, 2023

(30) Foreign Application Priority Data
Apr. 16, 2021 (CN) 202110412699.2

(51) Int. Cl. G06F 16/732; G06F 3/0484

(52) U.S. Cl. CPC G06F 16/7328; G06F 3/0484

(57) ABSTRACT

An embodiment of the present disclosure discloses an interaction method, which includes playing first video media content; in response to detecting a screen capturing operation at a first time, acquiring a played screenshot corresponding to the first time; and acquiring second video media content corresponding to the first time, wherein the second video media content includes part of the first video media content.

### CROSS-REFERENCE TO RELATED APPLICATIONS

The present application claims the priority to the Chinese patent application No. 202110412699.2 filed on Apr. 16, 2021 and entitled “INTERACTION METHOD AND APPARATUS, ELECTRONIC DEVICE, AND COMPUTER-READABLE STORAGE MEDIUM”, the disclosure of which is incorporated herein by reference in its entirety.

### TECHNICAL FIELD

The present disclosure relates to the field of multimedia content processing, and in particular, to an interaction method and apparatus, an electronic device, and a computer-readable storage medium.

### BACKGROUND

With the advancement of network technology and encoding and decoding technology, there comes rapid growth in a distribution market based on video media contents, so that a user can, through a terminal device, browse various video media contents anytime and anywhere.

### SUMMARY

The “SUMMARY” is provided to introduce concepts in a simplified form, which will be described in detail below in the following “DETAILED DESCRIPTION”. The “SUMMARY” is not intended to identify key features or essential features of the claimed technical solutions, nor is it intended to limit the scope of the claimed technical solutions.

In order to solve the above technical problem, embodiments of the present disclosure provide the following technical solutions.

In a first aspect, an embodiment of the present disclosure provides an interaction method, comprising: playing first video media content; in response to detecting a screen capturing operation at a first t time, acquiring a played screenshot corresponding to the first time; and acquiring second video media content corresponding to the first time, wherein the second video media content comprises part of the first video media content.

Further, the method further comprises: in response to detecting the screen capturing operation at the first time, displaying a video content acquiring control; and wherein the acquiring second video media content corresponding to the first time comprises: in response to detecting a trigger operation on the video content acquiring control, acquiring the second video media content corresponding to the first time.

Further, the video content acquiring control comprises prompt information, which prompts that the second video media content is acquirable after the trigger operation being performed on the video content acquiring control.

Further, the second video media content corresponding to the first time comprises: video media content having an ending point earlier than the first time and having a first duration; video media content taking the first time as an ending point and having the first duration; video media content having a start point later than the first time and having the first duration; or, video media content taking the first time as a start point and having the first duration.

Further, the second video media content comprises silent video media content.

Further, after the acquiring second video media content corresponding to the first time, the method further comprises: storing the second video media content in a preset storage location; and/or playing the second video media content.

Further, after the acquiring second video media content corresponding to the first time, the method further comprises: generating third video media content in accordance with the played screenshot and the second video media content.

Further, the generating third video media content in accordance with the played screenshot and the second video media content comprises: applying first special effects to the played screenshot to generate the third video media content, and/or applying second special effects to the second video media content to generate the third video media content.

Further, after the generating third video media content, the method further comprises: storing the third video media content in a preset storage location; and/or playing the third video media content.

In a second aspect, an embodiment of the present disclosure provides an interaction apparatus comprising a playing module and a processing module, characterized in that: the playing module is configured to play first video media content; the processing module is configured to, in response to detecting a screen capturing operation at a first time, acquire a played screenshot corresponding to the first time; and the processing module is further configured to acquire second video media content corresponding to the first time, wherein the second video media content comprises part of the first video media content.

Further, the interaction apparatus further comprises a display module, configured to, in response to detecting the screen capturing operation at the first time, display a video content acquiring control; and the processing module is configured to, in response to detecting a trigger operation on the video content acquiring control, acquire the second video media content corresponding to the first time.

Further, the video content acquiring control comprises prompt information, which prompts that the second video media content is acquirable after the trigger operation being performed on the video content acquiring control.

Further, the second video media content corresponding to the first time comprises: video media content having an ending point earlier than the first time and having a first duration; video media content taking the first time as an ending point and having the first duration; video media content having a start point later than the first time and having the first duration; or, video media content taking the first time as a start point and having the first duration.

Further, the second video media content comprises silent video media content.

Further, the interaction apparatus further comprises a storage module, wherein after the acquiring second video media content corresponding to the first time, the storage module is configured to store the second video media content in a preset storage location; and/or the playing module is further configured to play the second video media content.

Further, after the acquiring second video media content corresponding to the first time, the processing module is further configured to generate third video media content in accordance with the played screenshot and the second video media content.

Further, the generating third video media content in accordance with the played screenshot and the second video media content comprises: applying first special effects to the played screenshot to generate the third video media content, and/or applying second special effects to the second video media content to generate the third video media content.

Further, the interaction apparatus further comprises a storage module, wherein after the generating third video media content, the storage module is further configured to store the third video media content in a preset storage location; and/or the playing module is further configured to play the third video media content.

In a third aspect, an embodiment of the present disclosure provides an electronic device, comprising: a memory configured to store computer-readable instructions; and a processor configured to execute the computer-readable instructions to cause the electronic device to implement the method according to any item in the above first aspect.

In a fourth aspect, an embodiment of the present disclosure provides a non-transitory computer-readable storage medium for storing computer-readable instructions which, when executed by a processor, cause the processor to implement the method according to any item in the above first aspect.

In a fifth aspect, an embodiment of the present disclosure provides a computer program which, when executed by a processor, implements the method according to any item in the above first aspect.

In a sixth aspect, an embodiment of the present disclosure provides a computer program product having stored thereon a computer program, wherein the program, when executed by a processor, implements the method according to any item in the above first aspect.

The foregoing description is only an overview of the technical solutions of the present disclosure, and in order to enable clearer understanding of the technical means of the present disclosure so that the technical solutions may be implemented according to the contents of the description, and in order to make the above and other objectives, features, and advantages of the present disclosure more understandable, preferred embodiments are provided below, and their detailed descriptions made in conjunction with the accompanying drawings are as follows.

### BRIEF DESCRIPTION OF THE DRAWINGS

The above and other features, advantages, and aspects of the embodiments of the present disclosure will become more apparent in conjunction with the accompanying drawings and with reference to the following “DETAILED DESCRIPTION”. Throughout the drawings, identical or similar reference numbers refer to identical or similar elements. It should be understood that the drawings are schematic and that components and elements are not necessarily drawn to scale.

FIG. 1 is a schematic flow diagram of an interaction method provided in an embodiment of the present disclosure;

FIG. 2 is a schematic structural diagram of an interaction apparatus provided in an embodiment of the present disclosure;

FIG. 3 is a schematic diagram of an interaction interface displayed by an interaction apparatus provided in one embodiment of the present disclosure.

FIG. 4 is a schematic structural diagram of an electronic device provided in an embodiment of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein, but these embodiments are provided for a more complete and thorough understanding of the present disclosure. It should be understood that the drawings and the embodiments of the present disclosure are for exemplary purposes only and are not intended to limit the scope of protection of the present disclosure.

It should be understood that various steps recited in method implementations of the present disclosure may be performed in a different order, and/or performed in parallel. Moreover, the method implementations may include additional steps and/or omit performing the illustrated steps. The scope of the present disclosure is not limited in this respect.

The term “comprising” and variations thereof used herein are intended to be open-ended, i.e., “comprising but not limited to”. The term “based on” means “at least partially based on”. The term “one embodiment” means “at least one embodiment”; the term “another embodiment” means “at least one other embodiment”; the term “some embodiments” means “at least some embodiments”. Relevant definitions for other terms will be given in the following description.

It should be noted that the concepts such as “first” and “second” mentioned in the present disclosure are only used for distinguishing different devices, modules or units, and are not used for limiting the order or interdependence of functions performed by the devices, modules or units.

It is noted that the modifications of “one” or “more” mentioned in the present disclosure are intended to be illustrative rather than restrictive, and that those skilled in the art should appreciate that they should be understood as “one or more” unless otherwise clearly stated in the context.

Rich and diverse video media contents are obtained by a user through network distribution, and the user can obtain a played screenshot through a screen capturing operation in a process of browsing the video media contents by using a terminal device; if the user wishes to obtain a clip of the browsed video media content, he can only take a very complicated way, for example, storing the video media content and then importing it into a specific application to capture the clip, which is also a very cumbersome operation for a professional; therefore, there exists a technical problem in the industry that the user cannot conveniently acquire the clip of the browsed video media content.

The embodiments of the present disclosure disclose an interaction method and apparatus, an electronic device, and a computer-readable storage medium. The interaction method comprises: playing first video media content; in response to detecting a screen capturing operation at a first time, acquiring a played screenshot corresponding to the first time; and acquiring second video media content corresponding to the first time, wherein the second video media content comprises part of the first video media content. Through the technical solutions of the embodiments of the present disclosure, rich and diverse multimedia contents can be acquired in a flexible way in the process of playing the video media contents.

FIG. 1 is a flow diagram of an interaction method embodiment provided in an embodiment of the present disclosure. The interaction method provided in this embodiment may be performed by an interaction apparatus, which may be implemented as software or a combination of software and hardware, and may be integrated in a certain device in an interaction system, for example, in a terminal device. As shown in FIG. 1, the method comprises the following steps:

Step S101: playing first video media content;

In the step S101, the first video media content may be played through the interaction apparatus, and the first video media content includes, for example, a video with sound or a silent video. As an example, for example, the interaction apparatus has an application (APP) installed thereon, which, when being executed, may play the first video media content in an operation interface of the application. One exemplary scene includes, through the application, presenting a live-streaming room scene, where a user operating the interaction apparatus may, as an anchor user or a viewer user, enter a live-streaming room through the application and view a video stream of the live-streaming room (as can be understood by those skilled in the art, the video stream in the live-streaming room may be considered to be video media content); and another exemplary scene includes, through the application, presenting a video media content playing scene, where a user operating the interaction apparatus may select his interested video media content through the application and view the selected video media content.

Step S102: in response to detecting a screen capturing operation at a first time, acquiring a played screenshot corresponding to the first time.

In the step S102, the interaction apparatus may, in the process of playing the first video media content, in response to detecting the screen capturing operation at the first time, acquire the played screenshot corresponding to the first time. As described above, for example, in the process of playing, by the user, the first video media content through the interaction apparatus, the user may trigger a screen capturing operation in a preset manner, so that the interaction apparatus may, after detecting the screen capturing operation triggered by the user at the first time, in response to the screen capturing operation, acquire a played screenshot which corresponds to the first time. It may be understood by those skilled in the art that, the acquired played screenshot is a played screenshot acquired based on the first video media content played by the interaction apparatus, for example, the first video media content played by the interaction apparatus comprises a series of consecutive video frames, and the played screenshot may comprise a certain video frame in the series of consecutive video frames, or a part of the certain video frame (for example, an upper half of the certain video frame, a lower half of the certain video frame, or a part obtained by cropping the certain video frame in accordance with a preset length and width). Those skilled in the art may also understand that, the video screenshot is a played screenshot acquired by the interaction apparatus performing the screen capturing operation on the played first video media content, in response to detecting the screen capturing operation at the first time, so that there is a correspondence between the played screenshot and the first time. For example, the following scene is considered: the interaction apparatus plays the first video media content to a certain video frame at the first time, and the played screenshot comprises the certain video frame or a part of the certain video frame, then there is the above correspondence between the played screenshot and the first time, wherein the certain video frame played to at the first time may be a video frame being played at the first time or a first video frame to be played after the first time, and in addition, from an implementation perspective, the played screenshot may also be determined based on one or more video frames played before the first time or one or more video frames played after the first time, which is not specifically limited in the embodiment of the present disclosure. As an example, if it is a first video frame of the first video media content that is played or displayed by the interaction apparatus at the first time, the played screenshot may comprise the first video frame or a part of the first video frame; and as another example, the interaction apparatus may, after detecting the screen capturing operation at the first time, take a first video frame to be played or displayed after the first time or a part of the first video frame as the played screenshot. It should be noted that, in the embodiments of the present disclosure, there is no limitation on specific implementations of how to trigger the screen capturing operation, how to detect the screen capturing operation, and how to acquire the played screenshot in response to the screen capturing operation in the process of playing the first video media content; in addition, the acquired played screenshot may also be a played screenshot subjected to special effects processing such as beautifying, which is also not limited in the embodiment of the present disclosure.

Step S103: acquiring second video media content corresponding to the first time, wherein the second video media content comprises part of the first video media content.

In the step S103, the interaction apparatus acquires the second video media content corresponding to the first time, wherein the second video media content comprises part of the first video media content, for example, a video with sound or a silent video. As described above, for example, the first video media content played by the interaction apparatus comprises a series of consecutive video frames, and the second video media content comprises part of the first video media content, for example, the first video media content comprises a 1st video frame to a Qth video frame, and the second video media content may comprise a Mth video frame to a Nth video frame (may also comprise a part of each video frame of the Mth video frame to the Nth video frame, for example, an upper half of each video frame, a lower half of each video frame, or a part obtained by cropping each video frame in accordance with a preset length and width), and the second video media content may further comprise the Mth video frame and the Nth video frame (may further comprise a part of each video frame of the Mth video frame and the Nth video frame, for example, an upper half of each video frame, a lower half of each video frame, or a part obtained by cropping each video frame in accordance with a preset length and width), where Q, M, and N all are natural numbers, and M<N<Q.

As an alternative embodiment, the second video media content corresponding to the first time comprises: video media content having an ending point earlier than the first time and having a first duration; video media content taking the first time as an ending point and having the first duration; video media content having a start point later than the first time and having the first duration; video media content taking the first time as a start point and having the first duration; or, video media content having a start point earlier than the first time and an ending point later than the first time and having the first duration. For example, the second video media content comprises video media content having an ending point earlier than the first time and having a first duration, and referring to the foregoing example, the interaction apparatus plays the first video media content to the Qth frame at the first time, so that the second media content comprises the Mth frame to the Nth frame of the first video media content, and the second media content has the first duration; for example, the second video media content comprises video media content taking the first time as an ending point and having the first duration, and referring to the foregoing example, the interaction apparatus plays the first video media content to the Qth frame at the first time, so that the second media content comprises the Nth frame to the Qth frame of the first video media content, and the second media content has the first duration; for example, the second video media content comprises video media content having a start point later than the first time and having the first duration, and referring to the foregoing example, the interaction apparatus plays the first video media content to the Mth frame at the first time, the second media content comprises the Nth frame to the Qth frame of the first video media content, and the second media content has the first duration; for example, the second video media content comprises video media content taking the first time as a start point and having the first duration, and referring to the foregoing example, the interaction apparatus plays the first video media content to the Mth frame at the first time, so that the second media content comprises the Mth frame to the Nth frame of the first video media content, and the second media content has the first duration; or for example, the second video media content comprises video media content having a start point earlier than the first time and an ending point later than the first time and having the first duration, and referring to the foregoing example, the interaction apparatus plays the first video media content to the Nth frame at the first time, so that the second media content comprises the Mth frame to the Qth frame of the first video media content, and the second media content has the first duration.

By means of the above implementations, the user can, through the interaction apparatus, acquire the played screenshot and the second video media content based on the screen capturing operation, in the process of playing the first video media content, thereby flexibly acquiring rich and diverse multimedia contents and acquiring better user experience.

In one alternative embodiment, the method further comprises: in response to detecting the screen capturing operation at the first time, displaying a video content acquiring control; and the acquiring second video media content corresponding to the first time comprises: in response to detecting a trigger operation on the video content acquiring control, acquiring the second video media content corresponding to the first time. For example, in response to detecting the screen capturing operation at the first time, the interaction apparatus not only acquires a played screenshot corresponding to the first time, but also displays a video content acquiring control, which includes, for example, one visual touch area, and further includes, for example, one button or the like, so that when a user operating the interaction apparatus performs a trigger operation on the video content acquiring control, the interaction apparatus will detect the trigger operation and in response to the trigger operation, acquire the second video media content corresponding to the first time. As one alternative implementation, in response to detecting the screen capturing operation at the first time, the interaction apparatus may display a first interface, which includes the played screenshot and further includes the video content acquiring control; for example, the first interface occupies a lower area of the entire display interface of the interaction apparatus, and the first interface may further include other controls, for example, a sharing control for sharing the played screenshot, and the like.

Alternatively, the video content acquiring control comprises prompt information, which prompts that the second video media content is acquirable after the trigger operation being performed on the video content acquiring control. For example, on a display screen of the interaction apparatus, the prompt information is displayed on the video content acquiring control, wherein the prompt information may be, for example, text information “acquire just 10 seconds”, which means that after the played screenshot corresponding to the first time is acquired in the step S102, a user may perform a trigger operation on the video content acquiring control in accordance with the prompt information, so that the interaction apparatus, in response to detecting the trigger operation on the video content acquiring control, acquires second video media content with a total length of 10 seconds that corresponds to the first time (for example, the acquired second media content comprises video media content in the first video media content that takes a time which is 10 seconds before the first time as a start point, takes the first time as an ending point, and has a total length of 10 seconds).

In yet another alternative embodiment, after the acquiring second video media content corresponding to the first time, the method further comprises: storing the second video media content in a preset storage location; and/or playing the second video media content. For example, after the second video media content corresponding to the first time is acquired, the interaction apparatus may store the second media content in a preset location, for example, in an album, in a draft folder, or in a network location; and the interaction apparatus may play the second media content such that a user operating the interaction apparatus views the acquired second media content. Alternatively, after the second video media content is acquired, the interaction apparatus may provide and display a control corresponding to a storage function, and/or provide and display a control corresponding to a playing function, so as to in response to detecting a trigger operation on the control, perform the step of storing the second video media content and/or perform the step of playing the second video media content.

In another alternative embodiment, after the acquiring second video media content corresponding to the first time, the method further comprises: generating third video media content in accordance with the played screenshot and the second video media content. For example, the interaction apparatus may, after acquiring the second video media content corresponding to the first time, combine the second video media content with the played screenshot acquired in the step S102 to generate the third video media content, for example, adding the played screenshot as an image frame to a start (i.e., taking the played screenshot as a first image frame of the third video media content), an end (i.e., taking the played screenshot as a last image frame of the third video media content), or a middle part of the second video media content.

Alternatively, the generating third video media content in accordance with the played screenshot and the second video media content comprises: applying first special effects to the played screenshot to generate the third video media content, and/or applying second special effects to the second video media content to generate the third video media content. Here, the second special effects may be the same as the first special effects or different from the first special effects. For example, the interaction apparatus may, in accordance with the played screenshot, generate a series of video frames to which beauty special effects or motion special effects are applied, and add the series of video frames to a start (i.e., taking the played screenshot as a first image frame of the third video media content), an end (i.e., taking the played screenshot as a last image frame of the third video media content), or a middle part of the second video media content, to generate the third video media content. For another example, the interaction apparatus may apply preset special effects to the second video media content, and combine the second video media content to which the preset special effects are applied with the played screenshot to generate the third video media content. In addition, in the embodiment of the present disclosure, other various multimedia content processing manners of generating the third video media content in accordance with the played screenshot and the second video media content are not limited, and all of them can be applied to the embodiments of the present disclosure.

Alternatively, after the generating third video media content, the method further comprises: storing the third video media content in a preset storage location; and/or playing the third video media content. For example, after the generating the third video media content, the interaction apparatus may store the third video media content in a preset location, for example, in an album, in a draft folder, or in a network location; and the interaction apparatus may play the third media content such that a user operating the interaction apparatus views the generated third video media content. Alternatively, after the generating the third video media content, the interaction apparatus may provide and display a control corresponding to a storage function, and/or provide and display a control corresponding to a playing function, so as to in response to detecting a trigger operation on the control, perform the step of storing the third video media content and/or perform the step of playing the third video media content.

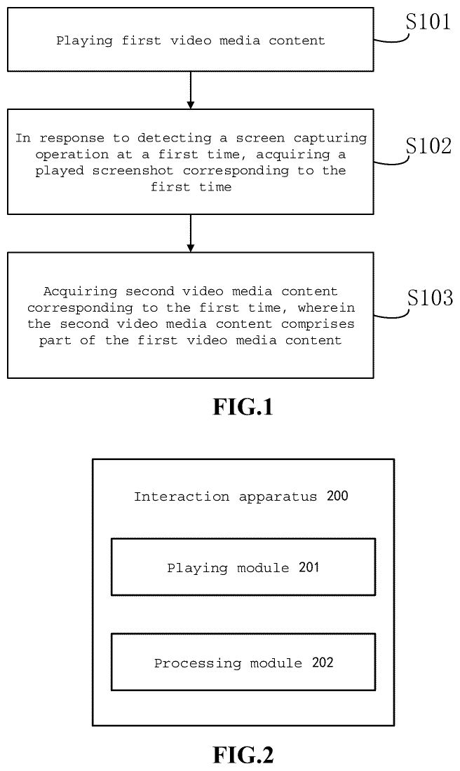

FIG. 2 is a schematic structural diagram of an interaction apparatus embodiment provided in an embodiment of the present disclosure. As shown in FIG. 2, the interaction apparatus 200 comprises a playing module 201 and a processing module 202, wherein:
the playing module 201 is configured to play first video media content;
the processing module 202 is configured to, in response to detecting a screen capturing operation at a first time, acquire a played screenshot corresponding to the first time; and
the processing module 202 is further configured to acquire second video media content corresponding to the first time, wherein the second video media content comprises part of the first video media content.

The apparatus shown in FIG. 2 may perform the method of the embodiment shown in FIG. 1, and for portions of this embodiment that are not described in detail, reference may be made to the related description of the embodiment shown in FIG. 1. For the execution process and technical effects of the technical solution, reference is made to the description in the embodiment shown in FIG. 1, which is not repeated here.

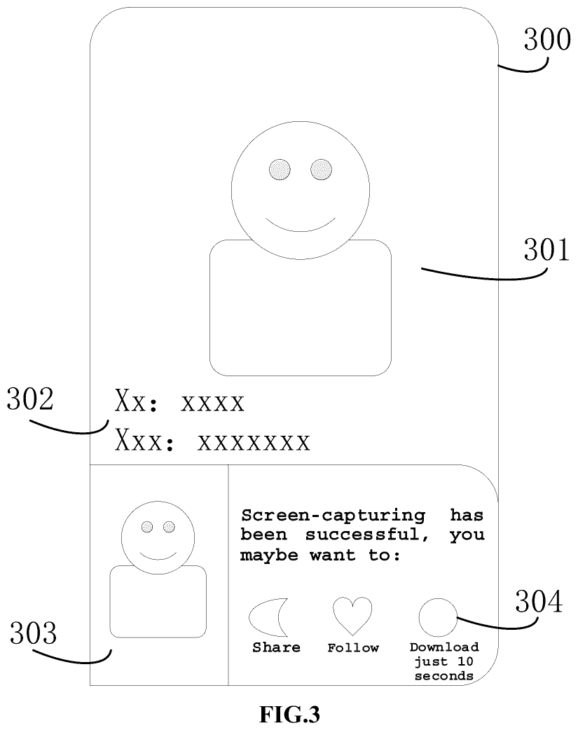

FIG. 3 is a schematic diagram of one embodiment of a display interface provided by the interaction apparatus shown in FIG. 2; referring to the foregoing example, the interaction apparatus may be applied in a live-streaming room scene, for example, an application is executed on the interaction apparatus to present a live-streaming room scene, and a user operating the interaction apparatus is, for example, a viewer user of the live-streaming room scene; as shown in FIG. 3, through the application, the viewer user may, in a display interface 300 on a screen of the interaction apparatus, view a video stream 301 of an anchor user in the live-streaming room that is pushed by a server (i.e., the first video media content played in the step S101); in FIG. 3, a comment area 302 associated with the live-streaming room is also displayed, which includes comment information sent by relevant users of the live-streaming room. In the process of viewing the video stream of the anchor, the viewer user triggers a screen capturing operation on the video stream 301 of the anchor user, so that the interaction apparatus, in response to detecting the screen capturing operation at a first time, acquires a played screenshot 303 corresponding to the first time, and alternatively, may display the acquired played screenshot 303 in the interaction interface shown in FIG. 3. It may be appreciated by those skilled in the art that, the acquired played screenshot may only include image content (s) of one or more image frames in the first video media content, for example, in the above live-streaming room scene, the acquired played screenshot 303 may include an image of one image frame in the video stream 301 of the anchor user in the live-streaming room, but does not include relevant contents in the comment area. Alternatively, the interaction apparatus, in response to detecting a screen capturing operation triggered by the viewer user at a first time, further displays a video content acquiring control 304, which comprises text information “download just 10 seconds”. The viewer user may perform a trigger operation on the video content acquiring control 304, so that the interaction apparatus, in response to detecting the trigger operation on the video content acquiring control 304, acquires the second video media content corresponding to the first time, for example, acquires a video stream of the anchor user with a total length of 10 seconds before the first time as the second video media content, and stores the second video media content in a draft folder of the application. The user can, through the interaction apparatus, acquire the played screenshot and the second video media content based on the screen capturing operation, in the process of playing the first video media content, thereby flexibly acquiring rich and diverse multimedia contents, and acquiring better user experience.

It should be noted that, for a specific implementation of acquiring the second video media content, it is not specifically limited in the embodiments of the present disclosure, so that any implementation may be applied to the embodiments of the present disclosure. As one alternative embodiment provided by the present disclosure, in the live-streaming room scene, the anchor user or the viewer user uses the interaction apparatus to play the video stream of the anchor user in the live-streaming room, i.e., the first video media content, and the interaction apparatus, in response to detecting the screen capturing operation at the first time, acquires the played screenshot corresponding to the first time, and acquires the second video media content corresponding to the first time; and, the interaction apparatus may acquire the second video media content by: the interaction apparatus sending, to a server, an acquisition request for the second video media content, which indicates the first time, and the server, in response to the acquisition request, in accordance with the first time and a duration of the second video media content, generates second video media content download information, which includes, for example, a URL address corresponding to the second video media content, and the interaction apparatus receives the second video media content download information from the server and downloads the second video media content from the server in accordance to the second video media content download information. It can be understood that, in the live-streaming room scene, the server will maintain a correspondence between the video stream of the anchor user, i.e., an image frame of the first video media content, and a playing time, so that the server will, after receiving the acquisition request from the interaction apparatus, determine a start time and an end time of the second video media content in accordance with the first time indicated by the acquisition request and the first duration of the second video media content, and in accordance with the correspondence, further determines, from the first video media content, download information corresponding to image frames between the start time and the end time, that is, determines the second video media content download information.

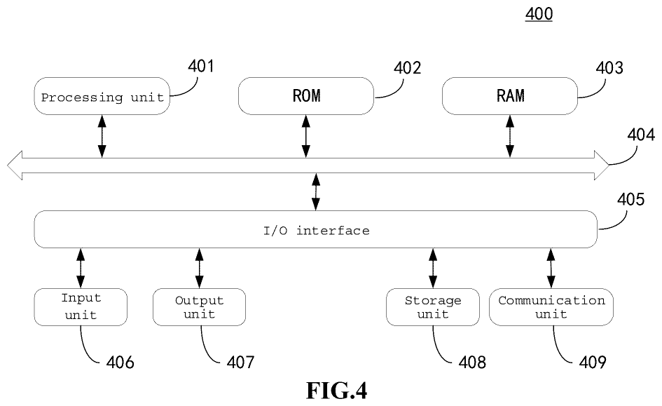

Reference is made below to FIG. 4, which shows a schematic structural diagram of an electronic device 400 suitable for implementing the embodiments of the present disclosure. The terminal device in the embodiment of the present disclosure may include, but is not limited to, a mobile terminal such as a mobile phone, a notebook computer, a digital broadcast receiver, a PDA (Personal Digital Assistant), a PAD (tablet computer), a PMP (Portable Multimedia Player), a vehicle-mounted terminal (e.g., a vehicle-mounted navigation terminal), or the like, and a fixed terminal such as a digital TV, a desktop computer, or the like. The electronic device shown in FIG. 4 is only an example, and should not bring any limitation to the functions and the scope of use of the embodiments of the present disclosure.

As shown in FIG. 4, the electronic device 400 may comprise a processing unit (e.g., a central processor, a graphics processing unit, etc.) 401, which may perform various appropriate actions and processes in accordance with a program stored in a read-only memory (ROM) 402 or a program loaded from a storage unit 408 into a random access memory (RAM) 403. In the RAM 403, various programs and data necessary for the operation of the electronic device 400 are also stored. The processing unit 401, the ROM 402, and the RAM 403 are connected to each other through a communication line 404. An input/output (I/O) interface 405 is also connected to the communication line 404.

Generally, the following unit may be connected to the I/O interface 405: an input unit 406 including, for example, a touch screen, touch pad, keyboard, mouse, camera, microphone, accelerometer, gyroscope, or the like; an output unit 407 including, for example, a liquid crystal display (LCD), speaker, vibrator, or the like; the storage unit 408 including, for example, a magnetic tape, hard disk, or the like; and a communication unit 409. The communication unit 409 may allow the electronic device 400 to communicate with other devices, either wirelessly or by wire, to exchange data. While FIG. 4 illustrates the electronic device 400 having various units, it should be understood that not all illustrated unit are required to be implemented or provided. More or less units may be alternatively implemented or provided.

In particular, in accordance with the embodiments of the present disclosure, the processes described above with reference to the flow diagram may be implemented as a computer software program. For example, the embodiment of the present disclosure comprises a computer program product, which comprises a computer program carried on a non-transitory computer-readable medium, the computer program containing program codes for performing the method illustrated by the flow diagram. In such an embodiment, the computer program may be downloaded from a network via the communication unit 409 and installed, or installed from the storage unit 408, or installed from the ROM 402. The computer program, when executed by the processing unit 401, performs the above-described functions defined in the method of the embodiment of the present disclosure.

It should be noted that the above computer-readable medium of the present disclosure may be a computer-readable signaling medium or a computer-readable storage medium or any combination of the two. The computer-readable storage medium may be, for example, but not limited to, an electronic, magnetic, optical, electromagnetic, infrared, or semiconductor system, apparatus, or device, or any combination of the above. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium containing or storing a program which can be used by or in conjunction with an instruction execution system, apparatus, or device. However, in the present disclosure, the computer-readable signaling medium may include a data signal propagated in baseband or as part of a carrier wave, in which computer-readable program codes are carried. Such a propagated data signal may take a variety of forms, including, but not limited to, electromagnetic signals, optical signals, or any suitable combination of the above. The computer-readable signaling medium may also be any computer-readable medium other than the computer-readable storage medium, which can send, propagate, or transmit a program for use by or in conjunction with an instruction execution system, apparatus, or device. The program codes contained on the computer-readable medium may be transmitted using any appropriate medium, including but not limited to: wires, optical cables, RF (radio frequency), or the like, or any suitable combination of the above.

In some implementations, a client and server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be contained in the above electronic device; or may exist separately without being assembled into the electronic device.

The above computer-readable medium has thereon carried one or more programs which, when executed by the electronic device, cause the electronic device to: perform the interaction method in the above embodiments.

Computer program codes for performing operations of the present disclosure may be written in one or more programming languages or a combination thereof. The above programming language includes, but is not limited to, an object-oriented programming language such as Java, Smalltalk, and C++, and further includes a conventional procedural programming language such as the “C” language or a similar programming language. The program codes may be executed entirely on a user's computer, partly on the user's computer, as a stand-alone software package, partly on the user's computer and partly on a remote computer, or entirely on the remote computer or a server. In a scene where the remote computer is involved, the remote computer may be connected to the user's computer through any type of network, including a local area network (LAN) or a wide area network (WAN), or connected to an external computer (for example, through the Internet using an Internet service provider).

The flow diagrams and block diagrams in the drawings illustrate the possibly implemented architecture, functions, and operations of the systems, methods and computer program products in accordance with various embodiments of the present disclosure. In this regard, each block in the flow diagram or block diagram may represent one module, program segment, or part of codes, which contains one or more executable instructions for implementing specified logical functions. It should also be noted that, in some alternative implementations, the functions noted in the blocks may also occur in a different order from those noted in the drawings. For example, two blocks shown in succession may, in fact, be executed substantially concurrently, and they may sometimes be executed in a reverse order, which depends upon functions involved. It will also be noted that each block of the block diagrams and/or flow diagrams, and a combination of blocks in the block diagrams and/or flow diagrams, can be implemented by a special-purpose hardware-based system that performs the specified functions or operations, or a combination of special-purpose hardware and computer instructions.

The involved units described in the embodiment of the present disclosure may be implemented by software or hardware. The name of the unit, in some cases, does not constitute a limitation on the unit itself.

The functions described above herein may be at least partially executed by one or more hardware logic components. For example, without limitation, an exemplary type of hardware logic components that may be used includes: a field programmable gate array (FPGA), application specific integrated circuit (ASIC), application specific standard product (ASSP), system on a chip (SOC), complex programmable logic device (CPLD), or the like.

In the context of this disclosure, a machine-readable medium may be a tangible medium, which may contain or store a program for use by or in conjunction with an instruction execution system, apparatus, or device. The machine-readable medium may be a machine-readable signaling medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

In accordance with one or more embodiments of the present disclosure, there is provided an electronic device, comprising: at least one processor; and a memory in communication connection with the at least one processor, wherein the memory has stored thereon instructions that is executable by the at least one processor, and the instructions is executed by the at least one processor to enable the at least one processor to perform any of the interaction methods in the foregoing first aspect.

In accordance with one or more embodiments of the present disclosure, there is provided a non-transitory computer-readable storage medium having stored thereon computer instructions, for causing a processor to perform any of the interaction methods in the foregoing first aspect.

In accordance with one or more embodiments of the present disclosure, there is provided a computer program which, when executed by a processor, implements any of the interaction methods in the foregoing first aspect.

In accordance with one or more embodiments of the present disclosure, there is provided a computer program product having stored thereon a computer program which, when executed by a processor, implements any of the interaction methods in the foregoing first aspect.

The foregoing description is only illustrations of preferred embodiments of the present disclosure and the technical principles employed. It should be appreciated by those skilled in the art that the disclosure scope involved in the present disclosure is not limited to the technical solutions formed by specific combinations of the technical features described above, but also encompasses other technical solutions formed by arbitrary combinations of the above technical features or equivalent features thereof without departing from the above disclosed concepts. For example, a technical solution formed by performing mutual replacement between the above features and technical features having similar functions to those disclosed in (but not limited to) the present disclosure.

1. An interaction method, comprising:
playing first video media content;
in response to detecting a screen capturing operation at a first time, acquiring a played screenshot corresponding to the first time; and
acquiring second video media content corresponding to the first time, wherein the second video media content comprises part of the first video media content.

2. The interaction method according to claim 1, wherein the method further comprises:
in response to detecting the screen capturing operation at the first time, displaying a video content acquiring control; and
wherein the acquiring second video media content corresponding to the first time comprises:
in response to detecting a trigger operation on the video content acquiring control, acquiring the second video media content corresponding to the first time.

3. The interaction method according to claim 2, wherein the video content acquiring control comprises prompt information, which prompts that the second video media content is acquirable after the trigger operation being performed on the video content acquiring control.

4. The interaction method according to claim 1, wherein the second video media content corresponding to the first time comprises: video media content having an ending point earlier than the first time and having a first duration; video media content taking the first time as an ending point and having the first duration; video media content having a start point later than the first time and having the first duration; video media content taking the first time as a start point and having the first duration; or, video media content having a start point earlier than the first time and an ending point later than the first time and having the first duration.

5. The interaction method according to claim 1, wherein the second video media content comprises silent video media content.

6. The interaction method according to claim 1, wherein after the acquiring second video media content corresponding to the first time, the method further comprises:
storing the second video media content in a preset storage location; and/or
playing the second video media content.

7. The interaction method according to claim 1, wherein after the acquiring second video media content corresponding to the first time, the method further comprises:
generating third video media content in accordance with the played screenshot and the second video media content.

8. The interaction method according to claim 7, wherein the generating third video media content in accordance with the played screenshot and the second video media content comprises:
applying first special effects to the played screenshot to generate the third video media content, and/or applying second special effects to the second video media content to generate the third video media content.

9. The interaction method according to claim 8, wherein after the generating third video media content, the method further comprises:
storing the third video media content in a preset storage location; and/or
playing the third video media content.

10. (canceled)

11. An electronic device, comprising:
a memory configured to store computer-readable instructions; and
a processor configured to execute the computer-readable instructions to cause the electronic device to implement the following operations:
playing first video media content;
in response to detecting a screen capturing operation at a first time, acquiring a played screenshot corresponding to the first time; and
acquiring second video media content corresponding to the first time, wherein the second video media content comprises part of the first video media content.

12. A non-transitory computer-readable storage medium for storing computer-readable instructions which, when executed by a processor, cause the processor to implement the following operations:
playing first video media content;
in response to detecting a screen capturing operation at a first time, acquiring a played screenshot corresponding to the first time; and
acquiring second video media content corresponding to the first time, wherein the second video media content comprises part of the first video media content.

13. (canceled)

14. (canceled)

15. The electronic device according to claim 11, wherein the processor is further configured to execute the computer-readable instructions to cause the electronic device to implement the following operation:
in response to detecting the screen capturing operation at the first time, displaying a video content acquiring control; and
wherein the acquiring second video media content corresponding to the first time comprises:
in response to detecting a trigger operation on the video content acquiring control, acquiring the second video media content corresponding to the first time.

16. The electronic device according to claim 15, wherein the video content acquiring control comprises prompt information, which prompts that the second video media content is acquirable after the trigger operation being performed on the video content acquiring control.

17. The electronic device according to claim 11, wherein the second video media content corresponding to the first time comprises: video media content having an ending point earlier than the first time and having a first duration; video media content taking the first time as an ending point and having the first duration; video media content having a start point later than the first time and having the first duration; video media content taking the first time as a start point and having the first duration; or, video media content having a start point earlier than the first time and an ending point later than the first time and having the first duration.

18. The electronic device according to claim 11, wherein the second video media content comprises silent video media content.

19. The electronic device according to claim 11, wherein after the acquiring second video media content corresponding to the first time, the processor is further configured to execute the computer-readable instructions to cause the electronic device to implement the following operation:
storing the second video media content in a preset storage location; and/or
playing the second video media content.

20. The storage medium according to claim 12, wherein the computer-readable instructions, when executed by the processor, further cause the processor to implement the following operations:
in response to detecting the screen capturing operation at the first time, displaying a video content acquiring control; and
wherein the acquiring second video media content corresponding to the first time comprises:
in response to detecting a trigger operation on the video content acquiring control, acquiring the second video media content corresponding to the first time.

21. The storage medium according to claim 20, wherein the video content acquiring control comprises prompt information, which prompts that the second video media content is acquirable after the trigger operation being performed on the video content acquiring control.

22. The storage medium according to claim 12, wherein the second video media content corresponding to the first time comprises: video media content having an ending point earlier than the first time and having a first duration; video media content taking the first time as an ending point and having the first duration; video media content having a start point later than the first time and having the first duration; video media content taking the first time as a start point and having the first duration; or, video media content having a start point earlier than the first time and an ending point later than the first time and having the first duration.

23. The storage medium according to claim 12, wherein the second video media content comprises silent video media content.
